(19) United States
(12) Patent Application Publication
(10) Pub. No.: US 2006/0134537 A1
(43) Pub. Date: Jun. 22, 2006

(54) Increased silicon microspheres in charge transfer layers

(75) Inventor: David Glenn Black, Longmont, CO (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/015,139

(22) Filed: Dec. 17, 2004

(51) Int. Cl. G03G 5/047

(52) U.S. Cl. 430/58.2; 430/58.4; 430/58.65

(57) ABSTRACT

A photoconductor having silicone microspheres in its outer, charge transport layer that are at least about 10 percent by weight of the layer and of diameter of about 3 to 6 microns, the amount larger than the typical 3 percent by weight of the microspheres displacing binder, not charge transfer agent.

### TECHNICAL FIELD

This invention describes the manufacture and use of laminate-type organic photoconductor for use in electrophotography (EP). More in particular, the invention relates to the inclusion of high levels of silicone microspheres in the charge transport layer of a dual layer organic photoconductor for use in laser printers.

### BACKGROUND OF THE INVENTION

The electrophotographic process involves the following steps: (1) Charging of an insulating, photoconducting imaging member to a predetermined voltage; (2) creating the image by exposing selected areas to monochromatic light and discharging this area of the photoconductor; (3) developing the electrostatically produced image with toner; (4) transferring the toned image from the imaging member to paper; (5) fusing of toner to paper. The process may also involve an image member-cleaning step to remove untransferred toner, and an erase step to eliminate residual charge from the imaging member. The imaging member, or photoconductor, may be viewed as the central technology in electrophotography.

Many types of photoconductors have been developed over the years that employ inorganic materials as selenium, amorphous silicon and zinc oxide. Currently, the low-end laser printer industry favors the use of organic photoconductors (OPC's) due to their inherently lower cost, relative environmental friendliness, ease of manufacturing, and high sensitivity.

Although several methods of preparing OPC's exist, the currently preferred type is the negatively charging, dual layer OPC in which a charge generating layer and a charge transport layer are laminated over a conductive substrate. For the negative charging OPC, the charge transport layer is applied over the charge generation layer.

The organic photoconductor in a laser printer must be both electrically and mechanically robust. The OPC is exposed to thousands of charge/discharge cycles during the course of cartridge life. The electrical properties should remain relatively consistent from the beginning to the end of cartridge life in order to insure consistent print quality. The OPC interacts with other components such as toner, charge roll, cleaner blade and paper that abrade the charge transport layer and limit the life of the OPC. Mechanical stresses can also affect the electrical properties of the OPC, thus making consistency of the charge/discharge characteristics further problematic.

As low-end laser printers enter commodity status, material and processing costs will come under increasing pressure. The charge generation (CG) pigment and the charge transport (CT) molecule represent the highest material cost in an organic photoconductor. Inexpensive additives that allow for the use of lower amounts of either the CG pigment or the CT molecules are therefore of interest. The greatest opportunity for material cost reduction comes from the charge transport molecule(s) due to the high concentration and thickness of the charge transport layer. The following patents are of interest:

U.S. Pat. No. 5,994,014 to Hinch, et al., issued Nov. 30, 1999, discloses the use of silicone microspheres and includes a range of particle sizes. Two reasons are cited for the inclusion of silicone microspheres, (1) improved wear performance; (2) minimize print darkening over life. The optimum particle size is about 1.0-3.0 microns. Lower particle sizes show less impact on wear, while larger sizes make the OPC susceptible to toner filming. The maximum silicone microsphere loading is 10%; loadings greater than this show increased susceptibility to toner filming, with little improvement in wear. The patent does not address replacing binder with silicone microspheres, rather, the microspheres are added ‘on top’ of the formulation, thus increasing the percent solids. The electrical properties are little changed by addition of the silicone microspheres up to 5%. The sensitivity falls off as the concentration of microspheres increases to 10%, as expected since the charge transport molecule concentration versus total solids is decreasing. The fatigue properties as a function of particle size are not addressed. The patent is assigned to Lexmark International, Inc.

U.S. Pat. No. 6,001,523 to Kemmesat, et al., issued Dec. 14, 1999 describes an electrophotographic photoconductor containing a polycarbonate A/Polycarbonate Z charge transport binder system for improved wear. One of the additives, which may be used in conjunction with the polycarbonate blend system, is a silicone microsphere. No size range is provided, and the loading ranges from 1-5%. The patent is assigned to Lexmark International, Inc.

U.S. Pat. No. 6,326,111 to Chambers, et al., issued Dec. 4, 2001 describes a photoconductor comprising a charge transport layer incorporating a hydrophobic silica, a fluorinated surfactant, and polytetrafluorethylene (PTFE). The charge transport layer shows improved wear versus a control that does not contain the additives. The purpose of the hydrophobic silica and the fluorinated surfactant is to act as a dispersion aid for the PTFE. Electrical properties of the resulting photoconductor are not discussed. The patent is assigned to the Xerox Corporation.

U.S. Pat. No. 5,096,795 to Yu, issued Mar. 17, 1992 discloses an electrophotographic imaging device with an outer layer containing either an inorganic or organic filler. Incorporation of these additives is said to reduce the coefficient of friction, improve wear resistance, diminish tensile cracking, and improve interlayer adhesion while maintaining electrical properties. The diameter of the insoluble particles should be less than around 4.5 microns. The patent is assigned to the Xerox Corporation.

U.S. Pat. No. 5,714,248 to Lewis issued on Feb. 3, 1998 describes the use of electrically conductive metal oxide particles together with electrically insulating metal oxide particles. A very broad range for the conductive metal oxide particles is claimed.

There remains a need to improve the electrical properties of an organic photoconductor that does not involve further addition of an expensive charge transport molecule. There is also a need to maintain electrical performance with lower transport molecule concentrations.

### DISCLOSURE OF THE INVENTION

In accordance with this invention addition of silicone microspheres of a narrow particle size, when added in place of the polymeric binder, results in an organic photoconductor with a greater sensitivity and lower residual potential versus a photoconductor which does not contain the silicone microspheres.

The electrophotographic photoconducting imaging member of interest is described as follows:
An electroconductive substrate.
A charge generation layer laminated over the electroconductive substrate. Said charge transport layer contains a photoconductive pigment dispersed in a film forming binder.
A charge transport layer laminated over the charge generation layer. Said charge generation layer comprises:
   A. A hydrazone such as DEH of from about 30 to about 45% by weight; thermoplastic binder such as polycarbonate A (PCA) ranging from about 20 to about 60 percent by weight; silicone microspheres around 4.5 microns plus or minus 1.5 micron in diameter in amount of from about 10 to about 35 percent by weight.
   B. A triarylamine such as TPD of from about 20% to about 35% by weight; thermoplastic binder such as polycarbonate A (PCA) ranging from about 30 to about 70 percent by weight; silicone microspheres around 4.5 microns plus or minus 1.5 micron in diameter in amount of from about 12 to about 35 percent by weight. Alternatively, a triarylamine such as TPD of an amount of about 35 percent by weight, thermoplastic binder such a PCA of about 55 percent by weight, and about 10 percent by weight silicone microspheres around 4.5 microns plus or minus 1.5 micron in diameter.

The preferred range of silicone microsphere ranges from about 10 to about 35 percent by weight with respect to total solids, with a corresponding decrease in polymer binder. Amounts lower than 10 percent do not appreciably enhance photoconductor electrical properties, while amounts greater that 35 percent result in a very unstable dispersion and rapid silicone microsphere settling. Most preferably, the silicone microspheres are added in about between about 15 and 25 percent by weight with respect to total solids.

Silica particles as specifically discussed in the foregoing U.S. Pat. No. 6,326,111 (Aerosil R-104, Aerosil 504 from Degussa Nippon Aerosil Corporation) are not silicone microspheres and do not function at all comparable to this invention. With those particles, silica agglomerates are clearly visible on the OPC surface. The roughness of the coating precludes evaluation of electrical properties due to charge roll arcing. Addition of silica ranged from 3-10 percent by weight of total solids in the charge transport formulation.

As described in the foregoing U.S. Pat. No. 5,994,014 of Hinch et al., addition of 10 percent 4.5 micron Silica microspheres ‘on top’ of a control formulation produces a photoconductor with nearly identical initial electrical properties versus those of a control. The patent shows that addition of more than 5 percent microspheres does not improve the wear properties of the organic photoconductor.

This invention provides improved efficiency by including high levels of silicone microspheres with a narrow particle size range. Improved efficiency may be defined as a deeper discharge for a given laser energy. One aspect of the invention describes an effective increase in charge transport molecule as judged by the increased efficiency of the OPC, without further addition of charge transport molecule. A second aspect describes the use of lower CTM levels in combination with silicone microspheres of a narrow particle size to give very similar electrical properties as an OPC formulation with a higher level of CTM in the absence of silicone microspheres.

### DESCRIPTION OF THE PREFERRED EMBODIMENTS

In the present invention, the charge transport layer is composed of: an optically transparent thermoplastic polymer binder such as polycarbonate; a charge transport molecule such as the hydrazone DEH, or the triarylamine TPD; silicone microspheres of about 4.5 microns in diameter possessing a narrow particle size distribution.

The preferred polycarbonate binder has a molecular weight around 30,000. One skilled in the art will realize that other molecular weights may also be used and that the viscosity of the resulting formulation will track the molecular weight of the binder. Most preferably, the polycarbonate binder consists of polycarbonate A such as MAKROLON 5208 available from Bayer Chemical Corporation.

The charge transport layer of a negatively charging photoreceptor is responsible for migrating photogenerated holes from the charge generation layer to the surface under the influence of an electric field. Toner development is dependent on the contrast between charged and discharged areas; higher contrast develops more toner and leads to darker print. The charge transport layer in a negatively charging photoconductor must therefore include molecules capable of migrating holes via radical cation chemistry. Typically, charge transport materials are easily oxidizable nitrogen-based molecules with a high degree of charge delocalization. The inventive contribution of this work is not directed to the charge transport molecule. Consequently, any charge transport molecule capable of accepting charge from the charge generation layer and then transporting the charge to the surface of the OPC under the influence of field may be used.

The preferred charge transport molecules are hydrazones or triarylamines. These molecules typically have molecular weights much lower than the polycarbonate matrix. Typical hydrazones include, but are not limited to p-diethylaminobenzalde diphenylhdrazone (DEH), p-diethylaminophenylbenzalde methylphenylhydrazone (DEMPH), p-diphenylaminobenzalde diphenylhydrazone (DPH). Typical triarylamines include, but are not limited to N,N′-diphenyl-N,N′-di(m-tolyl)-p-benzidine N,N′diphenyl-N,N′-bis (3-methylphenyl)-(1,1′-biphenyl)-4,4′-diamine (TPD), tritolylamine (TTA), N,N′,N″,N′″-tetrakis(4-methylphenyl)-(1,1′-biphenyl)-4,4′-diamine. Most preferably, the charge transport molecule is either the hydrazone DEH or the triarylamine TPD. The charge transport layer employed herein comprises from about 20 to about 50 percent of the charge transport molecule versus the total solids weight of the formulation. In order to increase the efficiency of the organic photoconductor, silicone microspheres are added to the charge transport layer. In order to achieve improved efficiency, an equivalent weight of the polymer binder is removed for each gram of silicone microsphere added to the formulation. The total percent solids therefore remain constant.

Silicone microspheres under the trade name TOSPEARL from Toshiba/GE are most preferred. This class of inorganic/organic material is insoluble in all known solvents. Silicon microspheres such a TOSPEARL are a complex silicon structure formed of organic and inorganic silicon compounds which provide a network structure with siloxane bonds extending in three dimensions. TOSPEARL has a spherical appearance and has a mean particle diameter ranging from about 0.1 to about 12.0 microns. Its moisture content at 105° C. is less than 5 percent by weight. It has a true specific gravity of 25° C. of about 1.32 and a bulk specific gravity ranging from about 0.1 to about 0.5. Its specific surface area ranges from about 15 to about 90 m²/gram and has a pH of about 7.5.

Preferably, the silicone microspheres range from 3-6 microns; most preferably, the mean particle size is 4.5 microns with a tight distribution about this value. The critical feature of smaller particle sizes is the high negative fatigue imparted on the photoconductor. Particle sizes intermediate between 6 and 8 microns were shown to harm the initial electrostatic properties of the photoconductor, while particle sizes greater than 12 microns appear on print as white spots (non-discharged areas) on all-black pages.

### EXAMPLE 1

Preparation of the titanylphthalocyanine dispersion for the charge generation layer is described in U.S. Pat. No. 5,994,014 to Hinch et al. The dispersion is coated over cylindrical anodized aluminum substrates to about 0.5 microns via dip coating. The thickness of the layer is conveniently tracked by recording the optical density using instruments such as a Macbeth TR524 densitimeter.

### EXAMPLE 2

The affect of silicone microsphere size on photoconductor electrostatics. Table 1 summarizes the charge transport formulation for Example 2.

TABLE 1
Summary of Material Weights (g) for Comparative Example 2.

| Material | Control | 10% 0.5μ Tospearl | 10% 2.0μ Tospearl |
|---|---|---|---|
| THF | 256.62 | 256.62 | 256.62 |
| 1,4-dioxane | 45.28 | 45.28 | 45.28 |
| HLS | 0.76 | 0.76 | 0.76 |
| SAVINYL | 0.76 | 0.76 | 0.76 |
| YELLOW | | | |
| DC-200 | 4 drops | 4 drops | 4 drops |
| DEH | 28.69 | 28.69 | 28.69 |
| MAKROLON 5208 | 45.29 | 37.74 | 37.74 |
| 0.5μ TOSPEARL | — | 7.55 | — |
| 2.0μ TOSPEARL | — | — | 7.55 |

7.55 grams of TOSPEARL microspheres are added to a vigorously stirring solution of THF/dioxane. The surfactant DC-200 (α,ω-bis(trimethylsiloxy)polydimethylsiloxane, Dow Coming) is added followed by the polycarbonate binder, DEH, SAVINYL YELLOW (Santoz Corporation) and HLS (Wingstay L-HLS, Goodyear Corporation). The control was prepared in the absence of silicone microspheres. The resulting charge transport formulations are coated over the CG layer as described in Example 1 via dip coating. Adjusting the coating speed controls the thickness. A voltage versus exposure energy experiment was performed on an in-house electrostatic tester with an expose-to-develop time of 61 ms and thickness of about 28 microns. An initial set of electrostatics was recorded and the photoconductors were exposed to 1000 charge/discharge cycles in order to examine the electrical fatigue. The results are summarized in Tables 2 and 3.

TABLE 2
Initial Electrostatic Properties for Example 2.

| Drum Description | V@0.00 μJ | V@0.15 μJ | V@1.00 μJ | dV@1 s |
|---|---|---|---|---|
| Control | 849.1 | 354.4 | 193.4 | 25.8 |
| 0.5 m TOSPEARL | 856.3 | 405.3 | 177.9 | 30.4 |
| 2.0 m TOSPEARL | 849.3 | 368.5 | 154.1 | 35.5 |

TABLE 3
Electrostatic Properties after 1k Fatigue for Example 2.

| Drum Description | V@0.00 μJ | V@0.15 μJ | V@1.00 μJ | dV@1 s |
|---|---|---|---|---|
| Control | 855.4 | 338.0 | 185.8 | 36.7 |
| 0.5 m TOSPEARL | 852.3 | 436.9 | 297 | 38.5 |
| 2.0 m TOSPEARL | 852.3 | 361.6 | 177.5 | 50 |

Table 2 shows that replacement of polycarbonate binder with TOSPEARL microspheres decreases the residual potential (1.00 μJ) versus the control. The potential at 0.15 μJ increases in the presence of both 0.5μ and 2.0μ TOSPEARL microspheres. Table 3 shows that the negative fatigue at residual potential increases with smaller size TOSPEARL microspheres. Note the 120V of negative fatigue at residual potential exhibited by the OPC containing 0.5μ TOSPEARL microspheres.

### EXAMPLE 4A

Organic photoreceptors were prepared as described in Examples 1 and 2. The photoconductor control contains 38 percent DEH, while the experimental photoconductors contain either 38 percent or 33 percent DEH, and 20 percent 4.5 micron TOSPEARL microspheres. The resulting charge transport formulations are coated over the CG layer as described in Example 1 via dip coating. A voltage versus exposure energy experiment was performed on an in-house electrostatic tester with an expose-to-develop time of 61 ms and thickness of about 28 microns. An initial set of electrostatics was recorded and the photoconductors were exposed to 1000 charge/discharge cycles in order to examine the electrical fatigue. The results are summarized in Tables 4 and 5.

TABLE 4
Summary of Initial Electrostatic Properties for Example 4.

| Drum Description | V@0.00 μJ | V@0.15 μJ | V@1.00 μJ | dV@1 s |
|---|---|---|---|---|
| 38% DEH Control | −853.5 | −411.6 | −254.6 | 19.1 |
| 38% DEH/20% 4.5μ | −854.4 | −389.3 | −177.2 | 25.3 |
| TOSPEARL | | | | |
| 33% DEH/20% 4.5μ | −850.3 | −413.5 | −225.2 | 20.4 |
| TOSPEARL | | | | |

TABLE 5
Summary of Electrostatic Properties after 1k Fatigue for Example 4.

| Drum Description | V@0.00 μJ | V@0.15 μJ | V@1.00 μJ | dV@1 s |
|---|---|---|---|---|
| Control | −859.1 | −390.0 | −249.0 | 50.2 |
| 38% DEH/20% 4.5μ | −858.4 | −377.9 | −179.9 | 30.1 |
| TOSPEARL | | | | |
| 33% DEH/20% 4.5μ | −856.7 | −397.9 | −224.8 | 29.3 |
| TOSPEARL | | | | |

Table 4 shows the decrease in electrical potential at both 0.15 μJ and 1.00 μJ for photoconductors containing 38 percent DEH and 20 percent 4.5μ TOSPEARL microspheres. The 33 percent, 20 percent 4.5ω TOSPEARL microspheres photoconductor has a lower residual potential than the control, while maintaining the same electrical potential at 0.15 μJ. This finding allows for the use of lower amounts of charge transport molecule. Note that all of the photoconductors show excellent electrical stability (Table 5).

### EXAMPLE 4B

The charge transport molecule DEH is relatively inexpensive, but has lower hole mobility when compared to triarylamine compounds such as TPD. This lower mobility leads to higher discharge characteristics, especially in cold environments. Higher discharge leads to less electrical contrast, and lighter print. Photoconductors that give adequate discharge at ambient temperatures, may provide less than ideal print darkness in colder environments. In order to demonstrate that improved electrical properties relate to higher optical density in cold environments, two 38% DEH control drums were compared to two 38% DEH/20% TOSPEARL microspheres-containing drums in a 30 ppm Lexmark OPTRA 622 laser Printer at 60° F. and 8% relative humidity (cold and dry conditions). Initial prints were obtained for all black pages at density settings 8 and 3, and an isopel page at density setting 8. The average optical densities are shown in Table 6.

TABLE 6
Optical Densities at 60° F., 8% Relative Humidity for Example 4B.

| Drum Description | D = 8 O.D. | D = 3 O.D. | Isopel, D = 8 O.D. |
|---|---|---|---|
| Control | 1.18 | 0.84 | 0.24 |
| 38% DEH; 20% | 1.42 | 1.2 | 0.39 |
| TOSPEARL | | | |

Table 6 shows the markedly higher optical densities derived from the TOSPEARL microspheres-containing photoconductors.

### EXAMPLE 5

Organic photoreceptors were prepared as described in Examples 1 and 2. The charge transport molecule is now TPD at 20, 25, or 30 percent with respect to total solids. Experimental photoconductors contain 20 percent 4.5 micron TOSPEARL microspheres. The resulting charge transport formulations are coated over the CG layer as described in Example 1 via dip coating. A voltage versus exposure energy experiment was performed on an in-house electrostatic tester with an expose-to-develop time of 61 ms and thickness of about 28 microns. The results are summarized in Tables 7 and 8.

TABLE 7
Summary of Initial Electrostatic Properties for Example 5.

| Drum Description | V@0.00 μJ | V@0.15 μJ | V@1.00 μJ | dV@1 s |
|---|---|---|---|---|
| 30% TPD Control | −855.8 | −242.6 | −116.0 | 14.7 |
| 30% TPD; 20% | −848.1 | −196.4 | −56.7 | 18.9 |
| 4.5μ TOSPEARL | | | | |
| 25% Control | −862.0 | −272.3 | −235.4 | 20.2 |
| 25% TPD; 20% | −849.7 | −224.0 | −94.8 | 17.9 |
| 4.5μ TOSPEARL | | | | |
| 20% Control | −850.4 | −518.4 | −478.8 | 32.4 |
| 20% TPD, 20% | −843.2 | −324.7 | −212.3 | 20.0 |
| 4.5μ TOSPEARL | | | | |

TABLE 8
Summary of Electrostatic Properties after 1k Fatigue for Example 5.

| Drum Description | V@0.00 μJ | V@0.15 μJ | V@1.00 μJ | dV@1 s |
|---|---|---|---|---|
| 30% TPD Control | −862.6 | −237.5 | −113.3 | 30.3 |
| 30% TPD; 20% | −847.3 | −202.0 | −61.3 | 22.4 |
| 4.5μ TOSPEARL | | | | |
| 25% Control | −870.0 | −274.3 | −230.1 | 22.5 |
| 25% TPD; 20% | −850.3 | −219.0 | −103.2 | 19.2 |
| 4.5μ TOSPEARL | | | | |
| 20% Control | −877.7 | −513.6 | −467.5 | 32.8 |
| 20% TPD, 20% | −848.1 | −307.3 | −218.2 | 24.6 |
| 4.5μ TOSPEARL | | | | |

A four-fold increase in residual potential is observed when lowering the TPD concentration from 30 to 20 percent, irrespective of the presence of silicone microspheres. However, the difference between the residual potential for the experimental photoconductor containing 30 percent TPD and 20 percent silicone microsphere is about one-half of that for the control. The electrical potential at 0.15 μJ is also more stable to moving from 30 to 20 percent TPD in the presence of silicone microspheres.

### EXAMPLE 6

Organic photoreceptors were prepared as described in Examples 1 and 2. The photoconductor control contains 38 percent DEH, while the experimental photoconductors contain either 38 percent or 33 percent DEH and 20 percent 6-8 micron TOSPEARL microspheres (TOSPEARL 2000B-PC from GE/Toshiba). The resulting charge transport formulations are coated over the CG layer as described in Example 1 via dip coating. A voltage versus exposure energy experiment was performed on an in-house electrostatic tester with an expose-to-develop time of 61 ms and thickness of about 27 microns. An initial set of electrostatics was recorded and the photoconductors were exposed to 1000 charge/discharge cycles in order to examine the electrical fatigue. The results are summarized in Tables 9 and 10.

TABLE 9
Summary of Initial Electrostatic Properties for Example 6.

| Drum Description | V@0.00 μJ | V@0.15 μJ | V@1.00 μJ | dV@1 s |
|---|---|---|---|---|
| Control | −859.1 | −289.2 | −221.5 | 21.5 |
| 20% 6-8μ Tosp. | −837.5 | 396.2 | −373.5 | 29.0 |
| 2000B-PC | | | | |

TABLE 10
Summary of Electrostatic Properties after
1k Electrical Fatigue for Example 6.

| Drum Description | V@0.00 μJ | V@0.15 μJ | V@1.00 μJ | dV@1 s |
|---|---|---|---|---|
| Control | −858.7 | −263.3 | −203.2 | 27.5 |
| 20% 6-8μ Tosp. | −828.4 | −675.6 | −644.8 | 38.6 |
| 2000B-PC | | | | |

Table 9 shows the catastrophic effect of 6-8 micron TOSPEARL microspheres on initial electrostatic properties. The photoconductor is degraded by about 100V at 0.15 μJ, and 150V at 1.00 μJ. Table 10 shows the magnitude of negative fatigue at both 0.15 μJ and 1.00 μJ.

The foregoing establishes that a wide range of alternative implementation are consistent with this invention.

What is claimed is:

1. A photoconductor comprising an electroconductive substrate, a charge generation layer on said substrate, and a change transport layer on said charge generation layer, said change transport layer comprising by weight of total solids:
about 30 to about 45 percent by weight of a hydrazone,
about 20 to about 60 percent by weight of a binder,
about 10 to about 35 percent by weight of silicon microspheres about 4.5 microns plus or minus 1.5 micron in diameter.

2. The photoconductor as in claim 1 in which said hydrazone is DEH.

3. The photoconductor as in claim 1 in which said mircospheres are about 15 to about 25 percent by weight

4. The photoconductor as in claim 2 in which said microspheres are about 15 to about 25 percent by weight.

5. The photoconductor as in claim 1 in which said microspheres are about 4.5 microns in diameter.

6. The photoconductor as in claim 2 in which said microspheres are about 4.5 microns in diameter.

7. The photoconductor as in claim 3 in which said microspheres are about 4.5 microns in diameter.

8. The photoconductor as in claim 4 in which said microspheres are about 4.5 microns in diameter.

9. A photoconductor comprising an electroconductive substrate, a charge generation layer on said substrate, and a change transport layer on said charge generation layer, said change transport layer comprising by weight of total solids:
about 20 to about 35 percent by weight of a triarlyamine,
about 30 to about 70 percent by weight of a binder,
about 12 to about 35 percent by weight of silicon microspheres about 4.5 microns plus or minus 1.5 micron in diameter.

10. The photoconductor as in claim 9 in which said triarylamine is TPD.

11. The photoconductor as in claim 9 in which said mircospheres are about 15 to about 25 percent by weight

12. The photoconductor as in claim 10 in which said microspheres are about 15 to about 25 percent by weight.

13. The photoconductor as in claim 9 in which said microspheres are about 4.5 microns in diameter.

14. The photoconductor as in claim 10 in which said microspheres are about 4.5 microns in diameter.

15. The photoconductor as in claim 11 in which said microspheres are about 4.5 microns in diameter.

16. The photoconductor as in claim 12 in which said microspheres are about 4.5 microns in diameter.

17. A photoconductor comprising an electroconductive substrate, a charge generation layer on said substrate, and a change transport layer on said charge generation layer, said change transport layer comprising by weight of total solids:
about 35 percent by weight of a triarlyamine,
about 55 percent by weight of a binder,
about 10 percent by weight of silicon microspheres about 4.5 microns plus or minus 1.5 micron in diameter.

18. The photoconductor as in claim 17 in which said microspheres are about 4.5 microns in diameter.
